(19) United States
(12) Patent Application Publication
(10) Pub. No.: US 2004/0091203 A1
(43) Pub. Date: May 13, 2004

(54) Ultra-fast RF MEMS switch and method for fast switching of RFsignals

(75) Inventors: Avigdor Huber, Yehud (IL); Miriam Hershkovitz, Carmiel (IL); Eliezer Ben-Gad, Merkaz (IL); Slava Krylov, Holon (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: TERAOP (USA) INC.

(21) Appl. No.: 10/698,462

(22) Filed: Nov. 3, 2003

Related U.S. Application Data
(63) Continuation-in-part of application No. 09/862,958, filed on May 22, 2001, now Pat. No. 6,668,109.
(60) Provisional application No. 60/230,700, filed on Sep. 7, 2000.
(60) Provisional application No. 60/468,789, filed on May 9, 2003.

(51) Int. Cl. G02B 6/35

(52) U.S. Cl. 385/18

(57) ABSTRACT

A RF switch comprises a substrate having two RF traces separated by a first gap, and coplanar ground traces separated from tile RF traces by a second gap, a membrane substantially parallel to the substrate and incorporating a conductive bridge, and an electrical mechanism for bringing the bridge into contact with the RF and ground traces, and for spacing the bridge apart from these traces. The membrane flexes in a membrane mode toward and away from the traces, providing extremely fast switching. A series configuration includes the bridge shorting the two RF traces, and a shunt configuration includes the bridge shorting the RF and aground traces. A separate embodiment provides a membrane vertical to the substrate and flexing in a direction parallel to it.

### CROSS REFERENCE TO RELATED APPLICATIONS

This application is a Continuation-in-part (CIP) of U.S. patent application Ser. No. 09/862,958 filed May 22, 2001, which claims priority from U.S. Provisional Application No. 60/230,700, filed Sep. 7, 2000. This application also claims priority from U.S. Provisional Application No. 60/468,789 filed May 9, 2003.

### FIELD OF THE INVENTION

This invention relates generally to radio frequency (RF) switches. More particularly, the present invention relates to ultra-fast micro-electro-mechanical system (MEMS) RF switches.

### BACKGROUND OF THE INVENTION

Radio frequency devices are commonly used in electronic systems where high frequency operation is required. One such commonly used device is a RF switch that performs connections at high speed. RF switches are typically implemented using PIN diodes or field effects transistors (FETs). Such switches are frequently found in phase shifters, switched filters transmitters and receivers for radar systems, ranging from large installations to anti-collision radar and communication systems, and from base stations to cell phones.

MEMS technology and devices are well known. The electrical functionality of MEMS devices is often limited by their mechanical durability. For optical switches, the key mechanical components are MEMS-based micro-machined mirrors fabricated on silicon chips using well established, varied-large-scale integration (VLSI) complimentary metal-oxide semiconductor (CMOS) foundry processes. These processes can include, but are not limited to, photolithography, material deposition, and chemical etching. Optical MEMS switches offer high-speed operation for optical systems, but suffer from speed limitations inherent in mechanical systems. RF MEMS switches include many of the same elements, and in addition electrical conductors used for RF traces and around planes.

RF switches are characterized by parameters like: switching time, insertion loss, isolation, bandwidth, linearity, size, RF power handling, control signal power, etc. The two most important parameters defining the performance of a RF switch are the isolation in the open state and the insertion loss in the closed state MEMS technology can be used to provide a RF switch with a set of outstanding characteristics, including high isolation, low insertion loss, small size, wide bandwidth and high linearity. A MEMS—based switch typically comprises a top contact in the form of a conductive cantilever ribbon, strip or membrane, positioned over a bottom contact pad. In an “ON” state, when actuated by electrostatic, magneto-static or other forces, the top contact is brought in contact with the bottom pad (“base”), forming a low impedance path for the RF signal. In an “OFF” state, an existing gap between the top contact and the base provides a high impedance to the RF circuit.

While the operating principles of MEMS optical or RF switching devices may appear to be simple, problems exist with conventional MEMS optical switching devices because of the need for precision control of a moveable optical or RF contact element in a high-speed environment. That is, RF MEMS switching devices lack precise and controlled movement of elements that provide the two states, ON and OFF of the switch. This lack of precise and controlled movement can be attributed to the low forces that are used to move the contact element. Typically, conventional MEMS switches utilize electrostatic methods to induce movement of the contact element. Electrostatic methods rely on the attraction of oppositely charged mechanical elements. Conventional switches typically use a single electrode to pull a structure having an electrical charge of opposite sign to the electrode.

Single electrode actuation does not provide precise and controlled movement of the deflecting or moving structure. For optical switch applications in which it is desirable to merely rotate the optical element or mirror, the single electrode actuation usually produces a moment and a force. When a moment and a force are produced, a translational movement of the deflecting structure is produced. This translational movement is undesirable when the optical element or mirror is designed to be simply rotated about an axis, but may be quite desirable in RF switch applications.

Almost all existing RF MEMS switches are characterized by a slow switching time, in the order of milliseconds, which prevents their use in applications such as phased array radars. Faster RF switches are known. Most recently, U.S. Pat. No. 6,426,687 to Osborn discloses a RF switch that has (see his FIG. 2) a diaphragm (plate) 22 supported by a mounting frame 58 through four arms (for example L-shaped) 42, 44, 46 and 48 and four respective anchors 50, 52, 54 and 56. The bending stiffness of the arms provides the necessary stiffness of the structure and permits the suspension of the plate above a RF line. Osborn's switch thus has elastic arms in the form of L-beams that work in a “bending” mode. In a bending mode, the mechanical stress varies linearly through the thickness of the arm. Therefore, a certain arm thickness is needed to reach a required stiffness. Beams working in a bending mode are quite sensitive to residual stress gradients.

Accordingly, there is a need in the art for a RF switching device that operates with much less than a millisecond switching time. Another need exists in the art for both optical and switching devices that provide for uniform element positioning and registration, as well as resistance to shock and vibration. Finally, a need exists in the art for RF switching devices that can be produced in high volumes by utilizing proven semiconductor process technology.

### SUMMARY OF THE INVENTION

The present invention provides an optical switching device that can increase the speed and precision at which optical signals are switched within an optical network. Similarly, and using essentially the same general structure in a preferred embodiment, the present invention provides a RF switching device that can increase the speed and precision with which RF signals are switched. Each optical and RF switching device according to the present invention can achieve relatively high switching speeds of between a few nano-seconds to a few hundreds of nano-seconds with precise angular movement. The switching speed can be defined as the movement of an element from a first switching position to a second switching position. A switching position can be defined as a position in which electrodes are applying a voltage to maintain one or more membrane supports (or simply “membranes”) and an optical or RF contact element at a predefined location. The relatively high switching speeds and precise angular movement of the optical or RF contact element cain be attributed to the utilization of a combination of electrodes and membrane made from predefined materials that react to the electrodes.

More specifically, the switching devices of the present invention preferably comprise an optical or RF contact element, one or more membranes that carry the optical or RF contact element, and upper and lower electrodes that control the deflection of the one or more membranes. The switching devices preferably comprise a micro-electro-mechanical system (MEMS) device that can be fabricated by addition or subtraction of material layers, e.g. using photolithography manufacturing techniques. The membrane preferably comprise planar strips fabricated from thin-layered materials such as silicon nitride (Si₃N₄), and the upper and lower electrodes are preferably electrical conductors made from materials such as titanium nitride (TiN) or metals such as gold.

Because of the materials used for the membrane, the membrane can be manufactured with relatively high tensile stresses. A membrane with high stresses can be easily stabilized and is thus suitable for supporting an optical or RF contact element, which is formed on a respective surface of the membrane. Further, a membrane with high stresses typically has increased stiffness so that it can provide rapid reaction of the optical or RF contact element. The optical or RF contact element typically moves in unison with the membrane, since it is usually firmly attached to the membrane and since the membrane has sufficient stiffness such that the optical or RF contact element will not lag behind any movement of the membrane. The stiffness of the membrane can also reduce or prevent low modes of vibration from occurring in the optical or RF contact element after moving the optical or RF contact element to a switching position.

In addition to providing membranes with high stresses, the present invention can also provide a method and system for switching optical or RF signals that employs multiple forces, as opposed to a single force, to move the optical or RF contact element into a switching position. More specifically, the present invention employs substantially pure moments to rotate the membranes and the attached element from a rest position to a switching direction. The substantially pure moments can be generated by activating opposing upper and lower electrodes that deflect individual membranes of respective pairs of membranes. In this way, undesirable translational movement of the membranes and of the optical or RF contact element can be substantially reduced or eliminated, which, in turn, increases the precision of the angular movement of the membranes and the optical or RF contact element.

Specifically, the present invention discloses a RF MEMS switch designed for the purpose of very fast switching (very low switching time) that utilizes small travel distance, high mechanical forces and high operating voltages. In common with the ultra-fast optical switch, the RF switch comprises a suspended membrane between a top electrode and a bottom electrode plane, the membrane itself being, or carrying separately, an electrically conductive contact (bridge) strip element. Also in common with the ultra-fast optical switch, the RF switch operates in a “membrane” mode described in more detail below, in contrast with the “bending” mode of Osborn's switch. In an open (OFF) state of the switch, the membrane rests in an upper position, away from RF trace or ground conductors. In a closed (ON) state of the switch, the membrane, through the conductor bridge, shorts between two co-planar sections of a RF trace separated by a gap, or between a co-planar RF trace and one or more ground traces.

The RF switch is accordingly of either a series type or a shunt type. The series RF switch is implemented by shorting two sides of an interruption (gap) in a RF trace using the contact bridge, which is activated by a force of the type mentioned above. The shunt switch is implemented by using the bridge to short between the RF trace and ground traces. The advantages of adding an additional upper electrode include making the “closed” to “open” transition faster due to the added force, and providing a damper for the membrane movement, thus making oscillations unimportant.

As mentioned, the RF switch comprises a bridge, one or more membranes that carry the bridge, and upper and lower electrodes that control the deflection of the one or more membranes. If the membrane itself is not electrically conductive (e.g. made of doped silicon), the switch comprises separate middle electrodes formed on the membrane. As in the case of the ultra-fast optical switch, the RF switch preferably comprises a MEMS device that can be fabricated by addition or subtraction photolithographic processes. The membrane is preferably a planar thin-layer strip fabricated from materials such as silicon nitride (Si₃N₄), and the upper and lower electrodes are electrical conductors made from materials such as titanium nitride (TiN) or gold.

In summary, according to the present invention there is provided a RF switch comprising: a non-conducting substrate having thereon two RF traces separated by a first gap, and at least one ground trace coplanar with the RF traces and separated from the RF traces by a second gap; at least one membrane positioned substantially in parallel and connected with the substrate, the at least one membrane configured to electrically bridge across at least one of the gaps, the membrane deflectable in a membrane mode; and an electrical mechanism for moving the at least one membrane between two switching configurations, a first switching configuration in which the at least one membrane bridges electrically at least one of the gaps, and a second switching configuration in which the at least one membrane leaves each of the gaps electrically open.

According to the present invention there is provided air electromagnetic wave switching device comprising a deflectable membrane configured to electrically bridge a gap between electrical conductors formed co-planarily on a non-conducting substrate; and means to deflect the membrane in a deflection mode, whereby the switching device is in a closed position when the deflection causes the electrical bridging of the gap, and whereby the switching device is in an open position when the deflection keeps the membrane apart from the gap.

According to one feature in the electromagnetic wave switching device of the present invention, the electrical conductors are RF traces and ground traces, and the switching device switches RF radiation.

According to the present invention there is provided a method for obtaining rapid switching using a MEMS device comprising providing a deflectable membrane configured to electrically bridge a gap between electrical conductors formed co-planarily on a non-conducting substrate, and deflecting said membrane in a membrane deflection mode, to bring said membrane to a closed switching position defined by an electrical bridging of said gap, and to bring said membrane to an open switching position in which said membrane is kept apart from the gap.

### BRIEF DESCRIPTION OF THE DRAWINGS

FIG. 1 is a perspective view of an optical switching device according to the present invention;

FIG. 2 is a side view of the optical switching device illustrated in FIG. 1;

FIG. 3 is an elevational view of the optical switching device illustrated in FIG. 1;

FIG. 4 shows in perspective a preferred embodiment of a RF series switch according to the present invention;

FIG. 5a is a front view of the RF switch illustrated in FIG. 4;

FIG. 5b shows schematically details of the substrate of the switch in FIG. 4;

FIG. 5c shows a more realistic view of RF and ground traces on a switch substrate;

FIG. 6 shows in perspective an alternative embodiment of a single membrane RF series switch according, to the present invention;

FIG. 7a shows in perspective a preferred embodiment of a RF shunt switch according to the present invention;

FIG. 7b is a front view of the RF switch of FIG. 7a;

FIG. 8 shows in perspective an alternative embodiment of a RF shunt switch according to the present invention;

FIG. 9 shows isomerically a more realistic series type switch design;

FIG. 10 shows a method for tuning the axial force in a membrane;

FIG. 11 shows isomerically a more realistic shunt type switch design.

FIG. 12 shows: (a) in perspective and (b) in a top view an embodiment of a perpendicular series RF switch;

FIG. 13 shows an exemplary process flow.

### DETAILED DESCRIPTION OF THE PREFERRED EMBODIMENTS

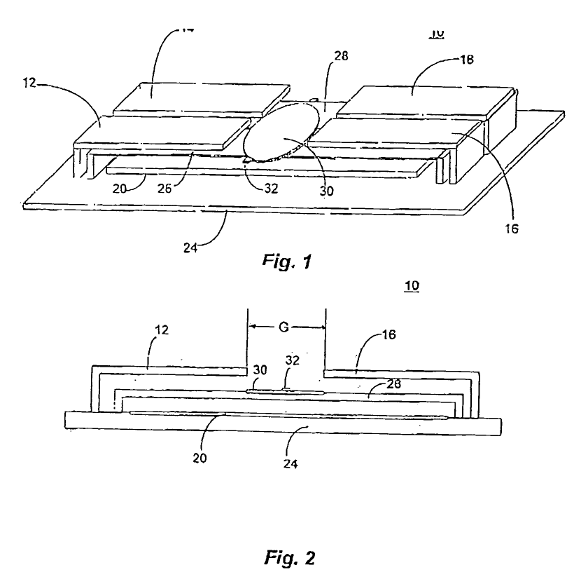

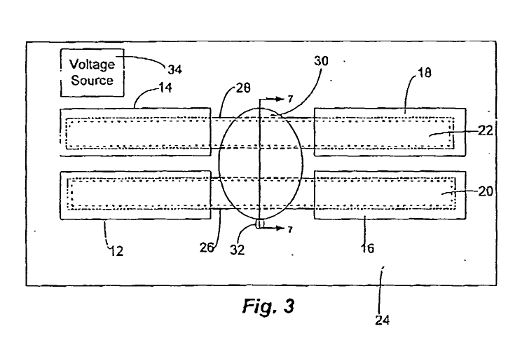

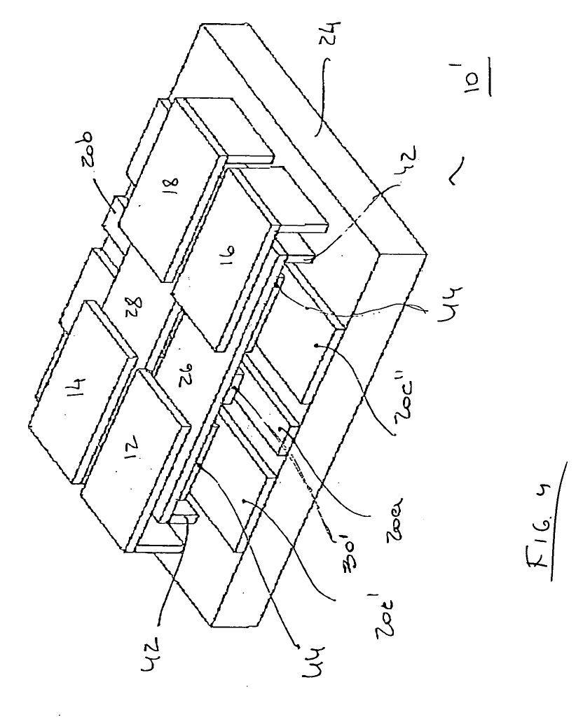

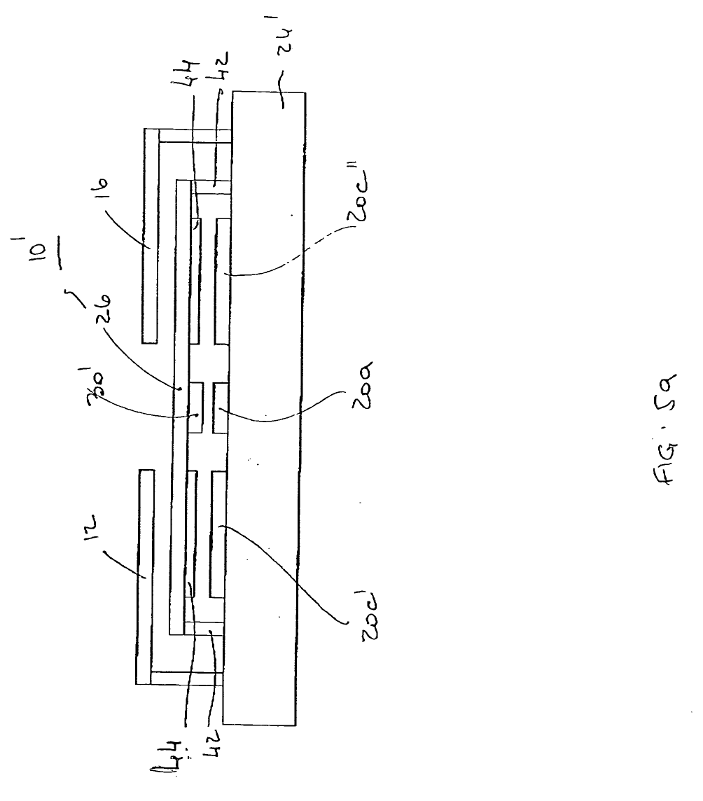

Referring now to the drawings, FIG. 1 illustrates an exemplary optical switching device 10 that includes electrodes 12, 14, 16, and 18 spaced from a substrate 24. Two electrodes 20, 22 are disposed adjacent to or within a substrate 24 (electrode 22 disposed within substrate 24 is illustrated in FIG. 3 with dashed lines). A first membrane support 26 and a second membrane support 28 (both referred to hereafter simply as membranes 26 and 28) are positioned between substrate electrodes 20, 22 and electrodes 12, 14, 16, and 18. Membranes 26, 28 space or separate an optical element 30 from substrate 24. As mentioned, one may dispense with the term “supports” which implies a membrane “supporting” a an optical or RF bridge element, and use just the term “membrane”. Thus, in the optical switch embodiment, optical element 30 is “supported” by membranes 26, 28.

While sets of three electrodes on a side of an optical element 30 can be connected to the same side of a power supply 34 shown in FIG. 3, each electrode can be controlled individually or in predetermined groupings. For example, to produce a moment or couple as discussed below, opposing sets of electrodes can be activated. In one exemplary embodiment, two electrodes on a same side and above membrane 28 (e.g. electrodes 14 and 18) can be activated at the same time as a diagonally opposed electrode disposed adjacent to the substrate 24 such as electrode 20. Membranes 26, 28 can be connected to a side of power supply 34 in order to close the circuit and build the electrostatic forces upon activation. Power supply 34 in the form of a voltage source can be an electronic driver. For example, one electronic driver can comprise transistor-transistor-logic (TTL) drivers and associated electronic up converters to provide the required voltage levels for electrodes 12, 14, 16, 18, 20, 22.

Optical element 30 can comprise a mirror made from reflective materials such as a layer of gold. Optical element 30 can also be referred to as a micro-mirror that is of the tilting mirror variety. However, element 30 is not limited to mirrors, and can include other optical elements such as a lens and other like structures that manipulate optical signals. Below we show that element 30 may be a RF contact element. As noted above, the optical element in the micro-mirror embodiment can be made from a layer of gold. However, other reflective materials include, but are not limited to, aluminum and other like reflective coatings.

The shape of optical element 30 in one exemplary embodiment has a substantially circular shape. However other shapes are not beyond the scope of the present invention. Other shapes include, but are not limited to, elliptical, square, rectangular, and other like shapes. In particular, the preferred shape of the RF contact element described in detail below is rectangular.

Referring now to FIG. 2, this diagram illustrates a side view of the optical switching device 10 illustrated in FIG. 1. In this diagram, the geometric shapes and relative spacings for the electrodes 12, 16, (as well as the other electrodes 14, 18) can be ascertained. Also, the relative geometry of the membrane 26 can also be ascertained. In this exemplary embodiment, electrodes 12, 16 spaced from substrate 24 have a substantially “L” shape cross-section. Membrane 26 has a substantially “C” shape cross-section. However, the present invention is not limited to these shapes illustrated in the drawings. The shapes of electrodes 12, 16 are typically a function of how much light and at what angle light energy is to be received within optical element 30. A space or gap G exists between electrodes 12, 16 (and likewise electrodes 14 and 18) so that optical or light energy can be reflected from the surface of optical element 30 when a light source (not shown) is spaced outside electrodes 12, 14, 16, and 18.

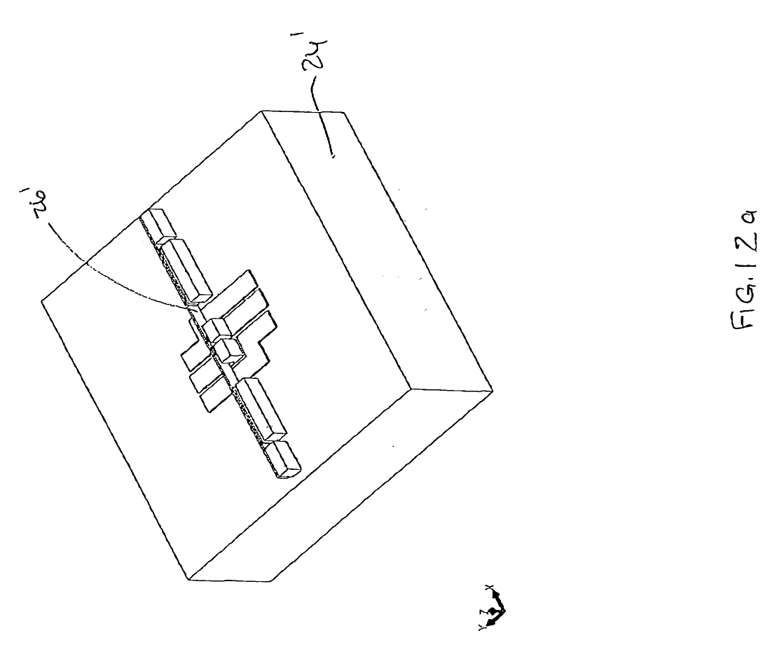

The shape of membrane 26 can also be a function of the desired movement direction of optical element 30. As shown in FIG. 10B of the parent U.S. application Ser. No. 2002/0,057,863, membrane 26 can have a substantially circular shape. In another exemplary embodiment, the position of the membranes 26, 28 can form a cross shape as shown in FIG. 10C therein.

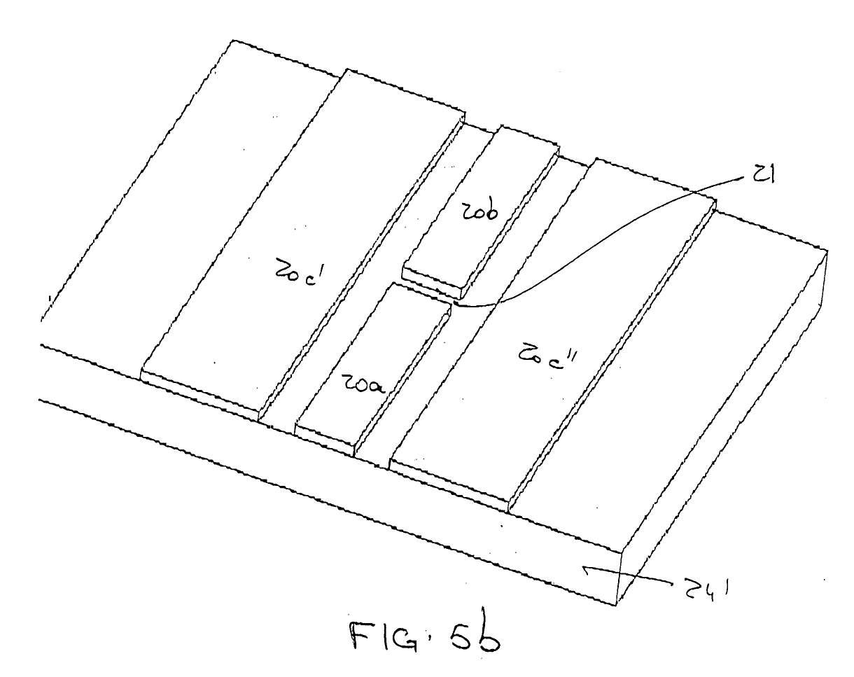

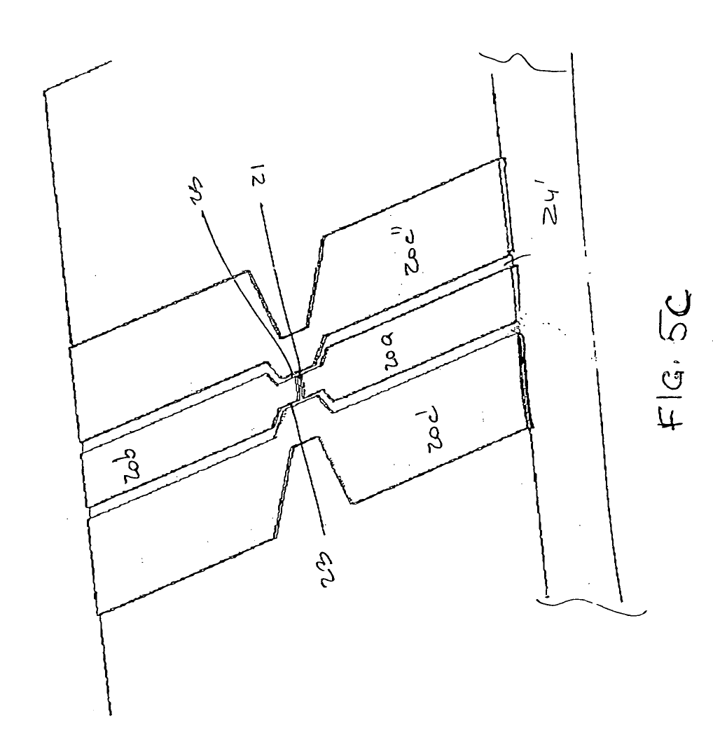

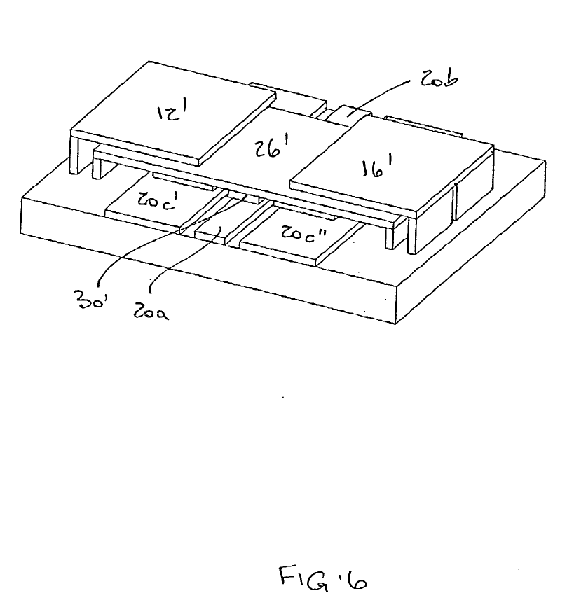

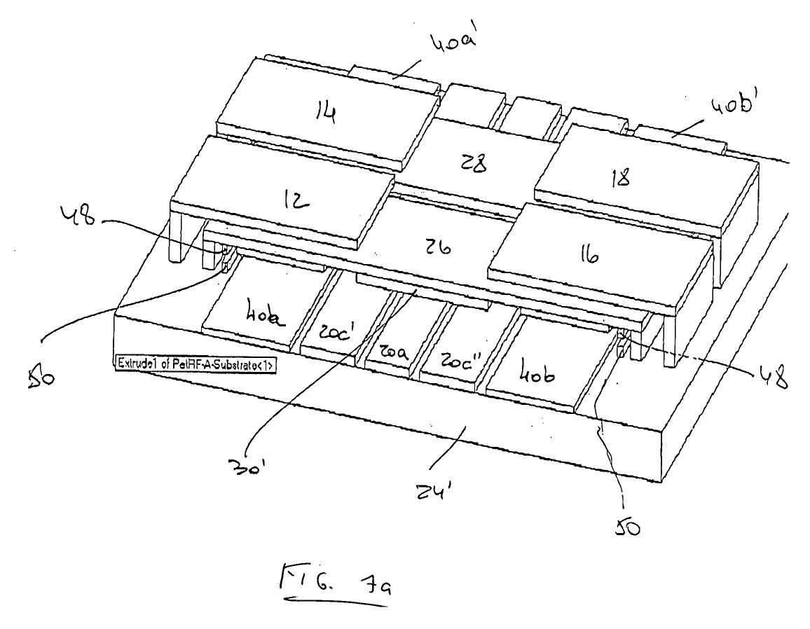

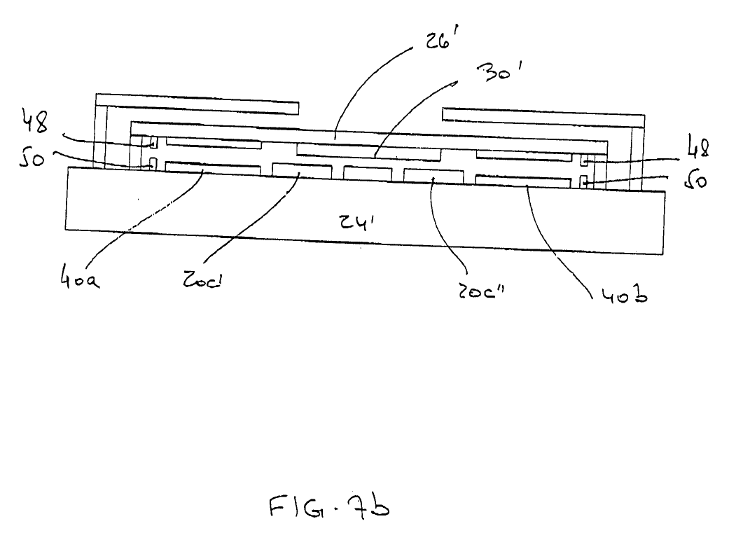

Referring back to FIG. 2, the membranes 26, 28 can be disposed between respective pairs of electrodes such that substantially pure moments can be generated. Details of the substantially pure moments generated by the present invention are discussed in further detail in FIG. 4 and FIG. 5 of the parent U.S. application Ser. No. 2002/0,057,863.

Membranes 26, 28 can be designed to have low inertia and high stiffness. This combination of low inertia and high stiffness properties permit membranes 26, 28 to move to their respective switching positions in a rapid manner. In one exemplary embodiment, membranes 26, 28 can be manufactured with high stresses within the range of 100 to 300 MegaPascals (MPa). A membrane with high stresses typically has increased stiffness so that it can provide rapid movement of an element such as optical element 30 or a RF contact element as discussed below, which is disposed on the membrane.

The electrodes can be made from electrical conductors such as titanium nitride (TiN). Electrodes 12, 14, 16, and 18 are spaced from substrate 24 by portions made from silicon nitride. Substrate 24 can be made from dielectric materials such as Silicon. Membranes 26, 28 can comprise strips made from silicon nitride (Si₃N₄). However, other materials are not beyond the scope of the present invention. Other materials include, but are not limited to, polysilicon and similar materials. The materials for membranes 26, 28 typically have a high Young's modulus such as 300 GigaPascals (Gpa), and a yield stress above the range of 1-2 GPa. The membrane materials typically comprise a dielectric material with very high breakdown voltage strength. In other words, the membrane materials work well with high voltages. While exemplary dimensions of all elements are given in Table II of the parent application, it is noted here that typical dimensions of the membranes of the present invention include 0.1-3 micron thickness, 30 micron width and 300 micron length. Exemplary electrode dimensions, as well as gaps between various switch elements are also given in Table II of the parent application.

One benefit of the switching devices of the present invention is that they can be manufactured on silicon chips using well-established, very-large scale integration (VLSI) complimentary metal-oxide semiconductor (CMOS) foundry processes. Further details of the manufacturing processes are discussed in the parent U.S. application with respect to Table IV therein. The switching devices of the present invention can be manufactured in high volume manufacturing environments

Referring now to FIG. 3, this diagram illustrates a top view of optical switching device 10 of FIG. 1. In this drawing, both pairs of electrodes 20, 22 disposed within substrate 24, are illustrated with dashed lines. Electrodes 20, 22 are illustrated to have a smaller surface area relative to membranes 26, 28, which are also illustrated with dashed lines to denote these hidden views. However, the present invention is not limited to electrodes 20, 22 having smaller surface areas relative to membranes 26, 28. It is not beyond the scope of the present invention to design electrodes 20, 22 disposed within substrate 24 to have surface areas larger than or substantially equal to their respective membranes 26, 28.

FIG. 4 shows in perspective a preferred embodiment of a switch according to the present invention. In general, such a switch may serve for switching of electrical waves of any frequency. More specifically, the description focuses of switching of RF waves. As explained below, the embodiment shown FIG. 4 is that of a RF “series” switch. FIG. 5a is a side view of the RF switch illustrated in FIG. 4. In these and following figures, like numerals represent like elements to those of the optical switch in FIGS. 1-3. FIG. 4 shows an exemplary RF switching device 10′ that includes top electrodes 12, 14, 16, and 18 spaced apart from and substantially parallel to a substrate 24′, the latter formed preferably of an insulating material such as Pyrex glass. In an alternative embodiment, shown in FIG. 6, electrodes 12 and 14 may be connected to form a single top left electrode 12′ and electrodes 16 and 18 may be connected to form a single top right electrode 16′. In yet another alternative embodiment, all four top electrodes may be united into one, forming a planar plate substantially parallel to the substrate. FIG. 5b shows details of substrate 24′, which includes two RF traces 20a and 20b and two ground traces 20c′ and 20c″, the latter configured to act also as bottom electrodes. A first membrane 26 and a second membrane 28 are positioned between ground traces 20c′ and 20c″ and top electrodes 12, 14, 16, and 18. In an alternative embodiment shown in FIG. 6, the two membranes may be united into a single membrane 26′. The description refers henceforth to a single “membrane” embodying one or more membranes such as membranes 26, 28. The membrane is itself, or carries an electrically conductive bridge element 30′ (hereinafter simple “bridge” 30′). Each membrane further has disposed adjacent to or within it one or more middle electrodes 44. In FIG. 4, electrodes 44 are shown as formed on the bottom side (facing electrodes/ground traces 20c′ and 20c″) of membrane 26. However, given the extremely small thickness of a membrane (typically 0.1-3 micron, depending on the material), a middle electrode may be formed on the top surface of the membrane, facing a top electrode, the switch still operating properly.

In contrast with optical element 30 above, bridge 30′ is disposed within, or preferably on, a bottom (facing substrate 24′) plane or surface of the membrane. Although the membrane may be formed of any of the materials mentioned above, the preferred embodiment uses silicon nitride or silicon as membrane material. Preferably, bridge 30′ is either a thin film metallic pad or “contact” deposited on the membrane by known methods such as evaporation or sputtering, and patterned to an appropriate shape. Alternatively, the membrane itself may be electrically conductive enough (e.g. doped silicon) to serve as a bridge, removing the need for a separate bridge element. The shape of bridge 30′ may be any shape that provides enough overlap to close a gap between the two RF traces or between the RF trace and ground traces. Preferably, RF traces 20a and 20b have a common equal thickness (height) larger enough than that of ground traces/electrodes 20c′ and 20c so that when bridge 30′ is brought into contact with the RF traces in the “series” configuration (see below) to “close” the switch, the bridge does not touch the ground traces.

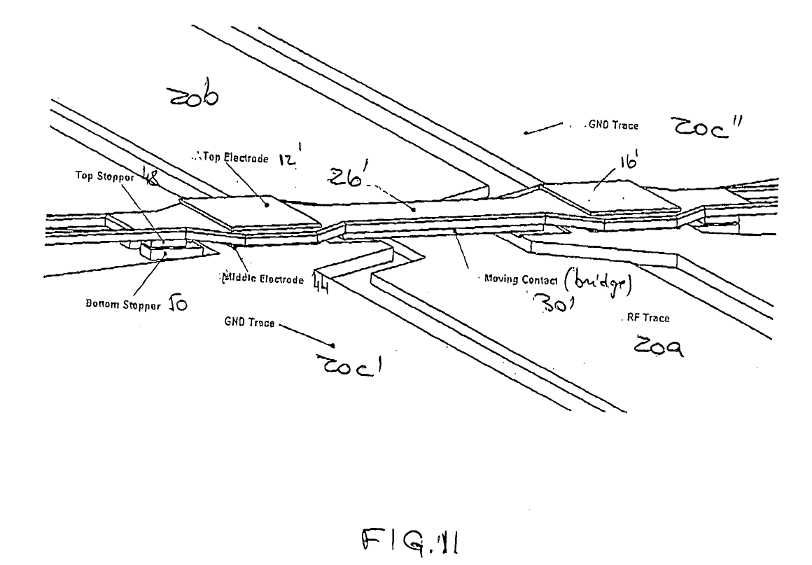

The membrane is attached to the substrate by essentially suspension elements or “hinges” 42, FIG. 4. These hinges are shown in a greatly exaggerated thickness and vertical positioning in the various figures. They may in fact be just thicker sections of the membrane attached to the substrate, or “springs” formed by etching sections of the membrane adjacent to the periphery, as shown in the isomeric view of FIG. 9. In effect, each membrane mentioned herein is somewhat similar to a thin, flexible trampoline, in which the central flexible section is attached to a surrounding rigid frame (substrate). The attachment is preferably only in select places, as shown in FIG. 9. The edges of the membrane are unmovable.

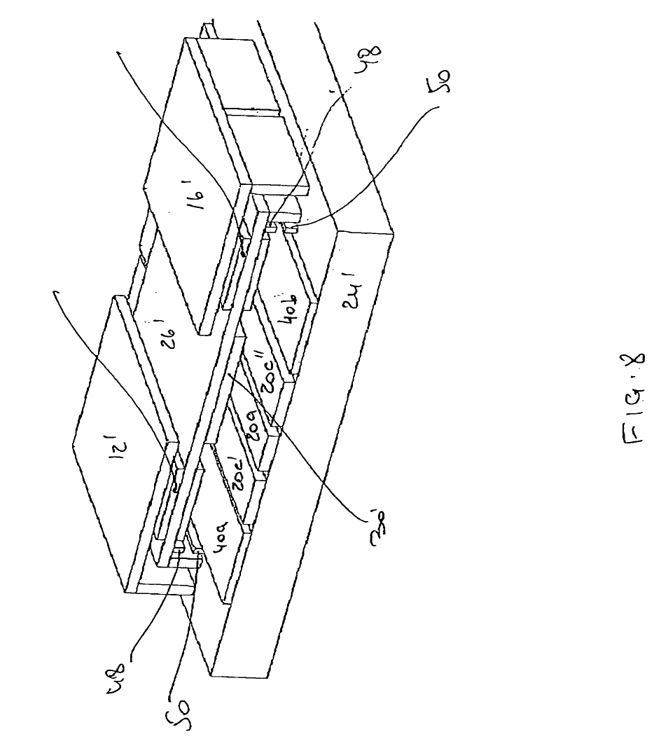

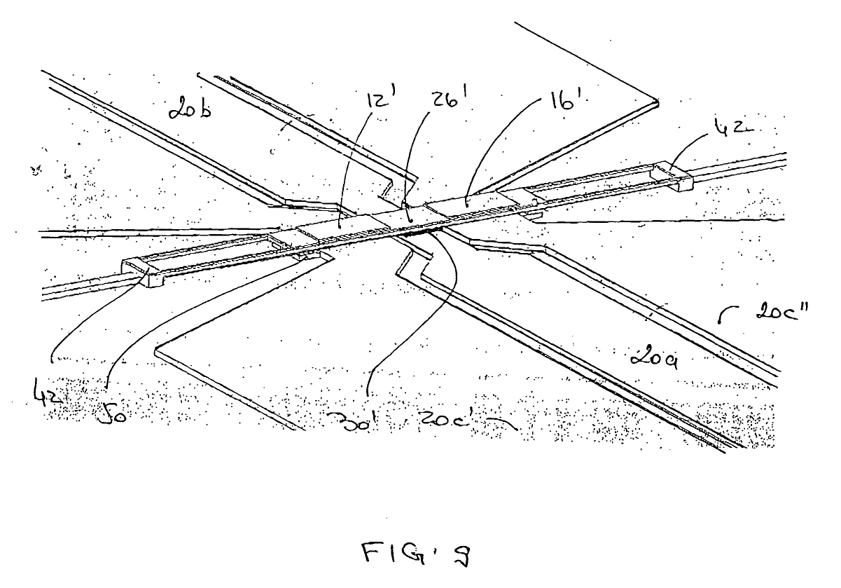

As in the optical switch above, while sets of three electrodes on a side of RF bridge 30′ can be connected to the same side of power supply 34 (which is not shown in any of the following figures), each electrode can be controlled individually or in predetermined groupings. Similarly to the optical switch, opposing sets of electrodes can be activated to produce a moment. In one exemplary embodiment, two electrodes on a same side and above membrane 28 (e.g. electrodes 14 and 18) can be activated at the same time as a diagonally opposed electrode disposed adjacent to substrate 24 such as a “front” electrode 40a′ (see FIG. 7a, where such an electrode is shown for a shunt switch, with the understanding that separate bottom electrodes may be equally useful in a series switch). The membrane (in one or two parts) can be connected to a side of power supply 34, in order to close the circuit and build the electrostatic forces upon activation. We emphasize that all upper electrodes as one group, and all lower electrodes as another group may also work together, i.e. be activated in unison. Alternatively, any RF switch of the present invention may be manufactured with sets of only two, bottom and middle, electrodes. Preferably, sets of electrodes include electrodes substantially aligned in the direction perpendicular to the membrane deflection direction. Some or all electrodes may be covered by a thin (typically 0.1-0.3 micron) dialectric layer to prevent RF leakage.

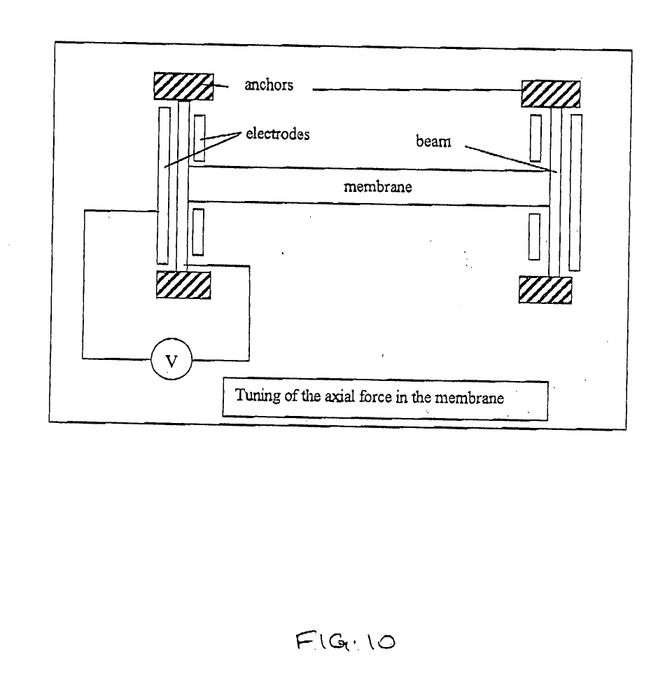

As mentioned, the RF switch of the present invention has two preferred configurations: a series one and a shunt one. In the series configuration shown in FIGS. 4-6, the bridge electrically shorts the two RF traces when brought into contact with them. That is, the bridge closes (bridges) a gap 21 (e.g. FIG. 5b) between the two co-planar RF traces 20a and 20b to form a “closed” state, gap 21 being sufficiently smaller than the bridge. In the shunt configuration shown in FIGS. 7a, 7b and 8, substrate 24′ has deposited thereon additional bottom electrodes 40a and 40b, separate from ground traces 20c′ and 20c″. In common with the optical switch design, electrodes 40 may be split into front electrodes and “back electrodes (marked 40a′ and 40b′). In a closed state, the bridge electrically shorts the ground traces and the RF traces. That is, the bridge is wide enough to overlap the RF trace, a gap 23 (e.g. FIG. 5c) between the RF trace and a ground trace, and at least a part of a ground trace. In a shunt configuration, the ground traces cannot serve as bottom electrodes, and therefore separate such electrodes are needed. In parallel with the series RF switch, the shunt RF switch may have only two top (left and right) electrodes, as shown in FIG. 8. The height of the RF and ground traces in the shunt switch must be essentially equal, to ensure good simultaneous contact by the bridge in the closed position.

RF switch 10′ further comprises one or more optional top stoppers 48 (shown for simplicity only in FIGS. 7a, b and 8, but evidently existing at least in some other series switch embodiments) positioned on the bottom side of the membrane, and one or more bottom stoppers 50 positioned co-planarily with the RF and ground traces on the substrate, respective top and bottom stoppers aligned with each other. The top and bottom stoppers serve to stop the movement of bridge 30′ toward the substrate, in order to leave an appropriate distance between bridge and substrate. This distance is such that it ensures the bridging action of bridge 30′ between the two RF traces in the closed series switch, and of bridge 30′ between a RF trace and a ground trace in the closed shunt switch.

In operation, the top electrode(s) interact with the bridge electrostatically (through the middle electrodes) to pull the bridge up, away from the substrate and the gap in the RF traces, to provide an “open” state of the switch. Conversely, the bottom electrode(s) interact with the bridge electrostatically to pull the bridge down, toward the substrate and the gap in the RF traces (or between RF and ground traces), to provide the closed state of the switch.

The “membrane mode” of deformation of the elastic elements is obtained in several ways. In-plane forces stretching the membrane combine a constant, deflection independent part and a variable part, which depends on the membrane deflection. The constant part arises from the residual stresses and the specially designed element geometry (for example a double clamped beam). The variable part is due to the elongation of the element during its deflection. In addition, the axial loads (and therefore the effective stiffness of the membrane element) can be easily tuned electro-statically or thermally. For typical geometries the stiffness-to-mass ratio for a membrane is higher than that for a beam of comparable geometry. In the membrane mode, the stress is constant though the thickness, the utilization of the material is much more effective and it is possible to fabricate essentially a thinner and therefore a lighter device. In addition, stretched membranes are less sensitive to residual stress gradients than beams working in bending mode.

In all cases, in order to obtain a membrane mode and not a bending mode, one needs a high slenderness (length-to-thickness ratio) of the element. Note that the shape and clamping conditions of the suspension elements (arms) described in the Osborn's patent do not permit deformation in a membrane mode, since in-plane forces do not arise in this case.

The membrane can be stretched by several methods used simultaneously or separately. Residual stresses arising due to the fabrication process may by themselves lead to the stretching of the membrane. The accurate control of these stresses is problematic in some cases. Additional stretching can be provided through the application of an axial force at the ends of the membrane, for example using electrostatic or thermal actuation, as described in FIG. 10. In this case the end of the membrane is attached to the central point of a flexible beam with the axis perpendicular to the axis of the membrane. The beam is loaded by an electrode and transfers the tensile force to the membrane. Another possibility to reduce the axial force within the membrane is based on the thermal actuation. The electric current is provided through the membrane or conductor placed on the membrane. The heating of the membrane leads to the thermal extension and reduction of axial force. Moreover, the stretching force nonlinearly depending on the membrane deflection arises when the deflection is comparable with the element thickness. In all cases the geometry of the element and the clamping conditions should be properly designed in order to obtain the membrane mode.

A stretched membrane has several advantages when used as a suspension element in RF application. First, as explained above, the relative stiffness (to mass) of the membrane is higher than that of a beam. The stiffness of a membrane of length L stretched by the stress σ₀ is kₘ=2σ₀A/L where A is the cross-sectional area. The bending stiffness of the beam of the same dimensions is k_{b}=αEI/L³, where the coefficient α depends on the boundary conditions of the beam. The ratio between the membrane and the beam stiffness can be reduced to the form kₘ/k_{b}=12/ασ₀·/E(L/h)², where h is the device thickness. For typical parameters of the stress (which can reach the values of ˜0.1%÷0.2% E) and slenderness L/h≈100÷200, the membrane stiffness is higher for a similar mass. This results from the fact that the stress distribution is constant through the thickness of the membrane, in contrast with the linear stress distribution in the bending element. Another result of the constant stress distribution in the membrane is its lower sensitivity to residual stress gradients. In addition, the reliability of a membrane stiffness element is higher, since the stresses are distributed more homogeneously along the membrane, and since there is no stress concentration near the clamped edge, as typical for beams.

To summarize, bridge 30′ is suspended, using two membranes 26 and 28, over RF lines 20a and 20b. The membranes are actuated by electrodes located under and/or above them. The deflection of the membranes leads to the displacement of the bridge. The membranes edges are attached to the substrate in such a way that the edges of the membrane are unmovable. As a result of the end conditions of this type, an axial stretching force arises during the up or down displacement of the bridge. The coupling between the bridge deflection and the axial force leads to the axial in-plane force being much larger that the bending force due to the change in the membrane curvature. This “membrane” mode of operation arises therefore in the case when the membrane thickness is smaller that the bridge deflection and the membrane edges are fixed, i.e., when a special design is provided. The special design is given in detail re the optical switch in parent U.S. application Ser. No. 2002/0,057,863. Another method to achieve the membrane mode is to provide the presence of residual axial stresses in the membrane material. Residual stresses can be obtained for example as a result of the fabrication process through the appropriate design of the technological process flow. In all cases the membrane stiffness is much higher that the bending stiffness of the suspension.

FIG. 9 shows isomerically a more realistic series type switch design, while FIG. 11 shows isomerically a more realistic shunt type switch design. In these figures, which are much more faithful in their scale to real life devices (except for thicknesses, which are still widely exaggerated), one can see the relative dimensions of each element described above in FIGS. 4-8. As mentioned, typical values and dimensions of all the common elements of the RF and optical switches are as listed in Table II of the parent application.

With the present invention, ultra-fast switching electromagnetic wave signals, and in particular of RF signals can be achieved with relative ease. That is, the switching devices of the present invention can provide precise movement of a conducting membrane bridge in a high speed-switching environment. The switching devices of the present invention can also rotate the bridge by generating simple and pure moments. The switching devices of the present invention can have at least two mechanically defined positions that facilitate very accurate and repeatable movement.

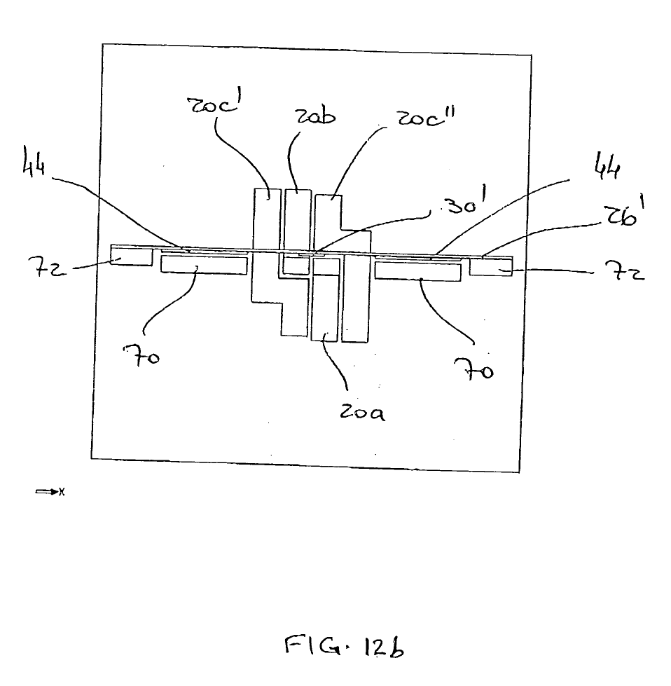

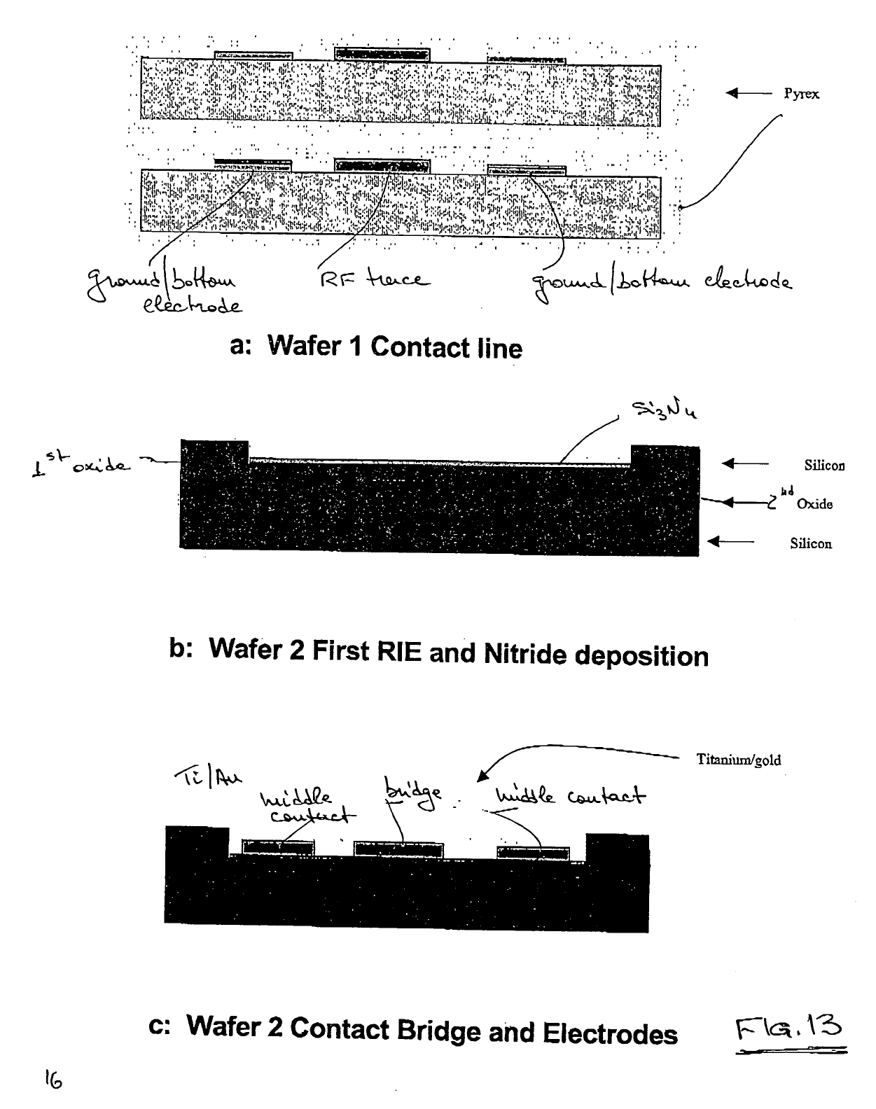

The membrane can be fabricated in two basic configurations. In a first “parallel” configuration, as described in FIGS. 4-9, the membrane width and length directions are parallel to the substrate and to the RF lines to be switched. In this case the membrane deflects in the direction perpendicular to the substrate. In a second, “perpendicular” configuration, shown schematically in FIGS. 12a and b for a series switch, the width and length directions of the membrane are in a plane perpendicular to the substrate. In other words, the membrane is perpendicular to the substrate, and is a “high aspect ratio” structure normally achieved by deep etching. The membrane can be fabricated, for example, from a single device layer of SOI wafer. The upright features (perpendicular to substrate 24′) are achieved by etching the device silicon layer with appropriate masking, while the membrane is similarly etched, for example using deep RIE. The membrane deflects in the direction parallel to the substrate, through the electrostatic action of electrode pairs 40 and 70. IN FIGS. 12a and b, the numbers used match the numbers in FIGS. 4-6, and indicate like functional elements.

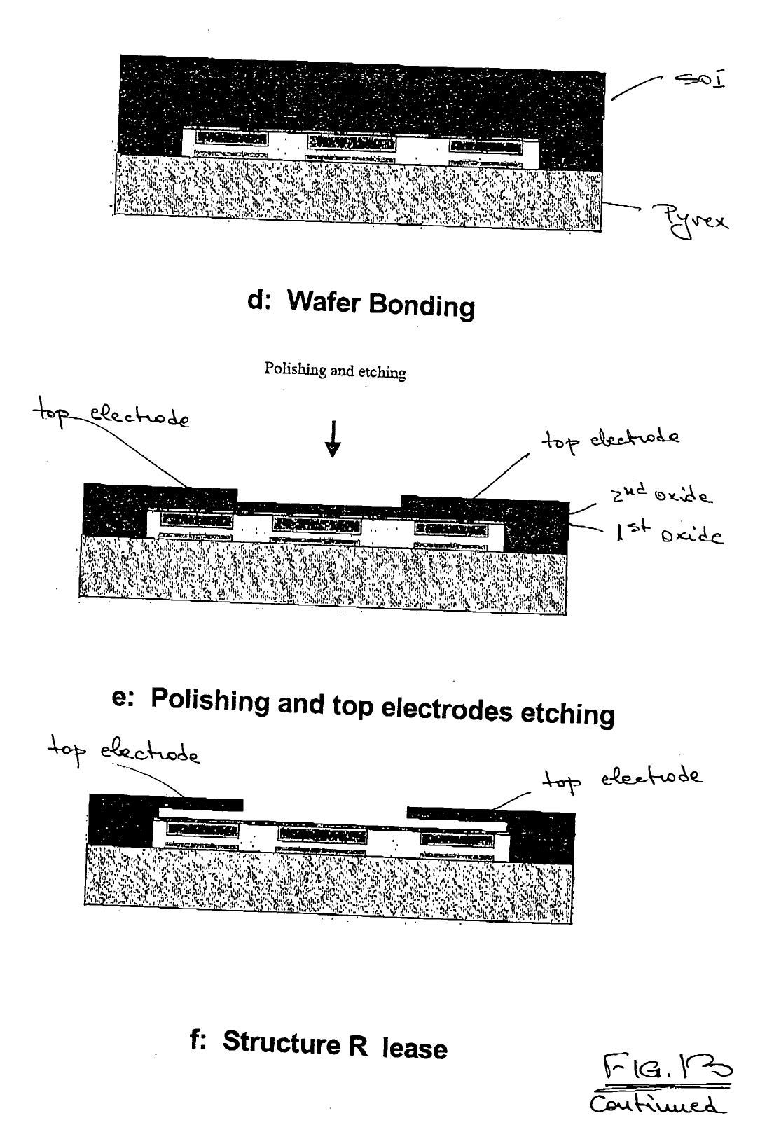

FIG. 13 shows an exemplary processing sequence for fabricating a RF switch according to the present invention. In general, a switching device according to the present invention may be fabricated using one, two or three wafers. The process illustrated here uses two wafers, a Pyrex glass wafer as a substrate, and a double SOI wafer in which the membrane and middle electrodes are formed. The sequence starts (a) with the deposition of contact lines of chrome/gold on the Pyrex substrate using the evaporation method. Two separate electro-plating depositions are then performed to provide a thickness of about 2 microns for the bottom electrodes and/or ground traces and about 3 microns for the RF traces. Next, in (b), reactive ion etching (RIE) is performed on the SOI wafer up to the first oxide etch stop, and a cavity is etched. Subsequently, a thin layer of nitride is deposited or, the SOI wafer using plasma enhanced chemical vapor deposition (PECVD). The silicon nitride is then etched using RIE, leaving a membrane of nitride within the cavity. In (c), titanium/gold is deposited on the Nitride using evaporation, to form the middle electrodes and the contact bridge. In (d), anodic bonding is used to bond the Pyrex wafer to the SOI wafer, with electrode pairs facing each other. In (e), the SOI wafer is polished and etched (i.e. thinned) from the back to the second oxide etch stop using chemical mechanical polishing (CMP). The cavity is then etched from the top to form top electrodes. Gold is deposited on the top, and patterning is used to make electrical contacts that connect the top and middle electrodes to an outside power source (not shown). In final step (f), HF is used to release the membrane. The device can now be freely actuated.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A RF switch comprising:
a. a non-conducting substrate having thereon two RF traces separated by a first gap, and at least one ground trace coplanar with said RF traces and separated from said RF traces by a second gap;
b. at least one membrane positioned substantially in parallel and connected with said substrate, said at least one membrane configured to electrically bridge across at least one of said gaps, said membrane deflectable in a membrane mode; and
c. an electrical mechanism for moving said at least one membrane between two switching configurations, a first switching configuration in which said at least one membrane bridges electrically at least one of said gaps, and a second switching configuration in which said at least one membrane leaves each of said gaps electrically open.

2. The RF switch of claim 1, wherein said configuration of said at least one membrane to electrically bridge is effected by said membrane being electrically conductive.

3. The RF switch of claim 1, wherein said configuration of said at least one membrane to electrically bridge is effected by said membrane having disposed thereon a conductive bridge.

4. The RF switch of claim 2, wherein said at least one membrane is made of conducting silicon.

5. The RF switch of claim 3, wherein said at least one membrane is made of silicon nitride.

6. The RF switch of claim 1, wherein said electrical mechanism includes thin-film electrodes operative to interact electrostatically to move said membrane in said deflection mode, thereby providing said two switching configurations.

7. The RF switch of claim 6, wherein said thin film electrodes include at least one set of bottom, middle anid top electrodes substantially aligned in a direction perpendicular to said substrate.

8. The RF switch of claim 7, wherein each said bottom electrode is identical with one of said ground traces.

9. The RF switch of claim 3, further comprising at least one pair of stoppers facing each other, one stopper of each said pair positioned co-planarily with said RF and ground traces on said substrate, and the other stopper of each said pair positioned co-planarily with said bridge, said stoppers serving to prevent unwanted contact between said bridge and an electrically conducting element on said substrate.

10. The RF switch of claim 1, wherein said first switching configuration in which said at least one membrane bridges electrically at least one of said gaps includes said at least one membrane connecting electrically said first gap, thereby providing a closed series RF switch configuration.

11. The RF switch of claim 1, wherein said first switching configuration in which said at least one membrane bridges electrically at least one of said gaps includes said at least one membrane connecting electrically said second gap, thereby providing a closed shunt RF switch configuration.

12. An electromagnetic wave switching device comprising:
a. a deflectable membrane configured to electrically bridge a gap between conductors formed co-planarily on a non-conducting substrate; and
b. means to deflect said membrane in a membrane deflection mode, whereby the switching device is in a closed position when said deflection causes said electrical bridging of said gap, and whereby the switching device is in an open position when said deflection keeps said membrane apart from said gap.

13. The switching device of claim 12, wherein said electromagnetic radiation is RF radiation.

14. The switching device of claim 13, wherein said membrane and said substrate are parallel to each other, and whereby said deflection is essentially perpendicular to said substrate.

15. The switching device of claim 13, wherein said membrane and said substrate are perpendicular to each other, and whereby said deflection is essentially parallel to said substrate.

16. The switching device of claim 13, wherein said RF conductors include two RF traces separated by a first gap, said electrical bridging including electrically shorting said RF traces across said first gap.

17. The switching device of claim 13, wherein said RF conductors include at least one RF trace and at least one ground trace, said at least one RF and ground traces separated by a second gap, and wherein said electrical bridging includes electrically shorting said at least one RF and ground traces across said second gap.

18. The switching device of claim 13, wherein said membrane is made of conducting silicon.

19. The switching device of claim 14, wherein said membrane is made of a non-conducting material, the switching device further comprising a conductive thin-film bridge disposed on said membrane and facing said substrate.

20. The switching device of claim 15, wherein said RF conductors are RF traces that further include sections perpendicular to said substrate and separated by a perpendicular gap identical with said first gap, each of said sections having a flat plane substantially parallel to said membrane, said parallel deflection of said membrane effecting an electrical bridging of said RF traces across said perpendicular gap in said closed position.

21. The switching device of claim 12, further comprising an additional stretching mechanism attached to said membrane, said stretching mechanism operative to change a stretching condition of said membrane, thereby assisting in obtaining said membrane deflection mode.

22. A method for obtaining rapid electromagnetic wave switching using a MEMS device comprising the steps of:
a. providing a deflectable membrane configured to electrically bridge a gap between electrical conductors formed co-planarily on a non-conducting substrate; and
b. deflecting said membrane in a membrane deflection mode, to bring said membrane to a closed switching position defined by an electrical bridging of said gap, and to bring said membrane to an open switching position in which said membrane is kept apart from said gap.

23. The method of claim 22, wherein said electromagnetic radiation is RF radiation, and wherein said electrical conductors are RF traces.
